(19) United States
(12) Patent Application Publication
(10) Pub. No.: US 2024/0083464 A1
(43) Pub. Date: Mar. 14, 2024

(54) AUTONOMOUS VEHICLE MONITORING SYSTEM USING SYSTEM-ON-CHIP ON-DIE RESOURCES

(71) Applicant: Motional AD LLC, Boston, MA (US)

(72) Inventors: Olivia Leitermann, Somerville, MA (US); Shailendra Deva, Saratoga, CA (US); Guillaume Binet, Pittsburgh, PA (US); Berlinda Bai, Troy, MI (US); Dean Degazio, Edgewood, PA (US)

(21) Appl. No.: 18/139,891

(22) Filed: Apr. 26, 2023

Related U.S. Application Data
(60) Provisional application No. 63/363,596, filed on Apr. 26, 2022.

(51) Int. Cl. B60W 60/00

(52) U.S. Cl. CPC B60W 60/0018

(57) ABSTRACT

A peer-to-peer monitoring system and method that enable monitoring of execution of various performance core processes by one or more performance core processors in, for example, an autonomous vehicle system. Each performance core processor is integrated on a single chip or die with a corresponding monitoring core processor that monitors its performance, execution of performance core processes, etc. Each monitoring core processor is communicatively coupled to all other monitoring core processors in the peer-to-peer monitoring systems and monitors those processors. Each monitoring core processor, upon receiving a communication from another monitoring core processor may perform various actions to ensure continuity of operation of the peer-to-peer monitoring system and/or the performance core processors.

### CROSS-REFERENCE TO RELATED APPLICATIONS

The present application claims priority to U.S. Provisional Patent Appl. No. 63/363,596, filed Apr. 26, 2022, and incorporates herein by reference in their entireties the disclosure of the U.S. Non-Provisional Patent application with the Attorney Docket No.: 46154-0438001/12022068, titled “SCALABLE CONFIGURABLE CHIP ARCHITECTURE” filed on Apr. 26, 2023 and the U.S. Non-Provisional Patent application with the Attorney Docket No.: 46154-0445001/12022075, titled “DISTRIBUTED COMPUTING ARCHITECTURE WITH SHARED MEMORY FOR AUTONOMOUS ROBOTIC SYSTEMS” filed on Apr. 26, 2023.

### BACKGROUND

An autonomous vehicle is capable of sensing its surrounding environment and navigating without human input. Upon receiving data representing the environment and/or any other parameters, the vehicle performs processing of the data to determine its movement decisions, e.g., stop, move forward/reverse, turn, etc. The decisions are intended to safely navigate the vehicle along a selected path to avoid obstacles and react to a variety of scenarios, such as, presence, movements, etc. of other vehicles, pedestrians, and/or any other objects. Each system in the vehicle that performs processing may be subject to errors, faults, etc., timely detection and resolution of which is important to safe operation of the vehicle and/or any of its components.

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4A is a diagram of certain components of an autonomous system;

FIG. 4B is a diagram of an implementation of a neural network;

FIGS. 4C and 4D are a diagram illustrating example operation of a CNN;

FIGS. 5A and 5B illustrate diagrams of example monitoring systems;

FIG. 6A is a diagram of an example of a monitoring system, according to some implementations of the current subject matter;

FIG. 6B is a diagram of an example chiplet system;

FIGS. 6C-6E are diagram of other examples of monitoring systems, according to some implementations of the current subject matter; and

FIG. 7 illustrates an example monitoring process, according to some embodiments of the current subject matter.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

### General Overview

A vehicle (such as an autonomous vehicle) can process images from its cameras using a streamline image processing pipeline that omits steps not necessary for images used in, e.g., vehicle navigation. For example, an image captured by a camera is typically processing using an image and signal processing pipeline (ISP). Some of the processing steps produce images more suitable for the human eye but are not necessary for use of the image in vehicle navigation. Those steps can be omitted in the pipeline.

Some of the advantages of these techniques include faster image processing of camera data. By omitting unnecessary image processing steps, an image captured by the vehicle camera can be ready for use in navigation more quickly.

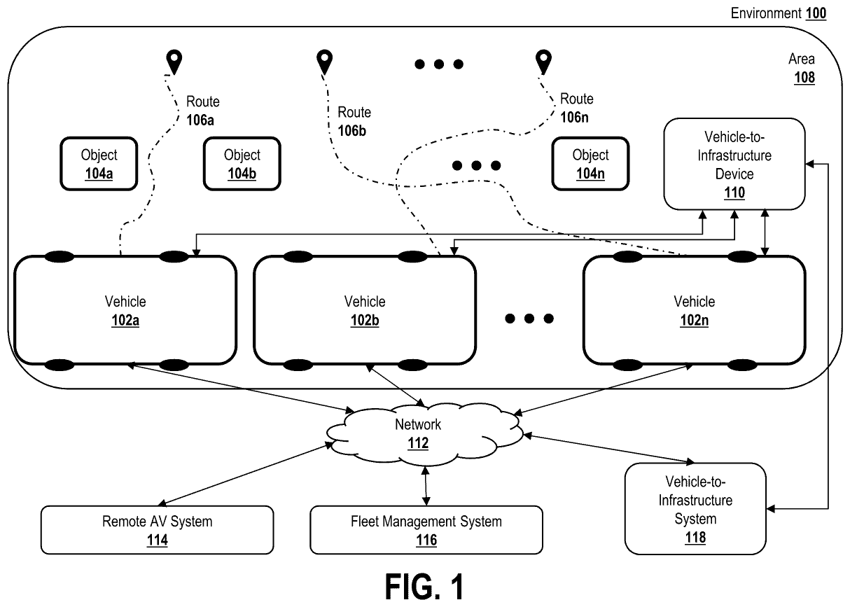

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

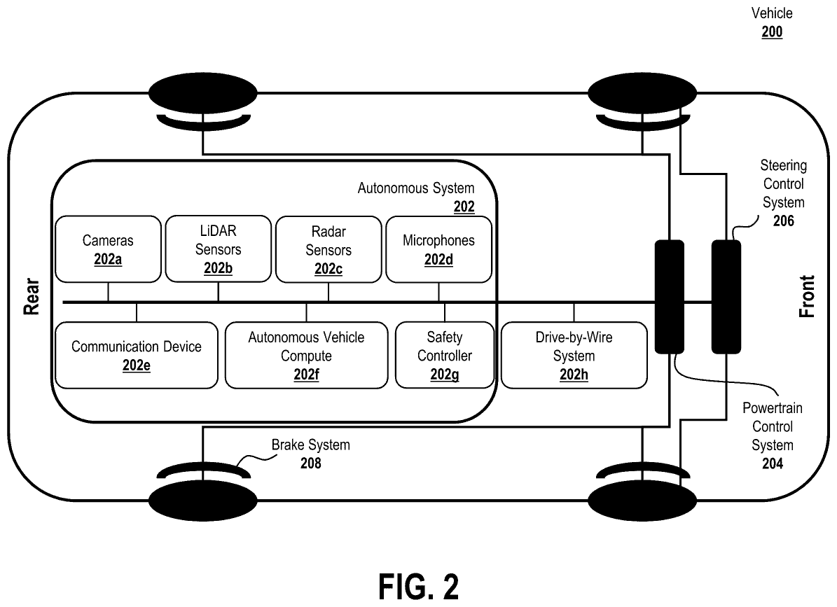

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and ends at a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited look ahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure or Vehicle-to-Everything (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 (which may be the same as, or similar to vehicles 102 of FIG. 1) includes or is associated with autonomous system 202, powertrain control system 204, steering control system 206, and brake system 208. In some embodiments, vehicle 200 is the same as or similar to vehicle 102 (see FIG. 1). In some embodiments, autonomous system 202 is configured to confer vehicle 200 autonomous driving capability (e.g., implement at least one driving automation or maneuver-based function, feature, device, and/or the like that enable vehicle 200 to be partially or fully operated without human intervention including, without limitation, fully autonomous vehicles (e.g., vehicles that forego reliance on human intervention such as Level 5 ADS-operated vehicles), highly autonomous vehicles (e.g., vehicles that forego reliance on human intervention in certain situations such as Level 4 ADS-operated vehicles), conditional autonomous vehicles (e.g., vehicles that forego reliance on human intervention in limited situations such as Level 3 ADS-operated vehicles) and/or the like. In one embodiment, autonomous system 202 includes operation or tactical functionality required to operate vehicle 200 in on-road traffic and perform part or all of Dynamic Driving Task (DDT) on a sustained basis. In another embodiment, autonomous system 202 includes an Advanced Driver Assistance System (ADAS) that includes driver support features. Autonomous system 202 supports various levels of driving automation, ranging from no driving automation (e.g., Level 0) to full driving automation (e.g., Level 5). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, drive-by-wire (DBW) system 202h, and safety controller 202g.

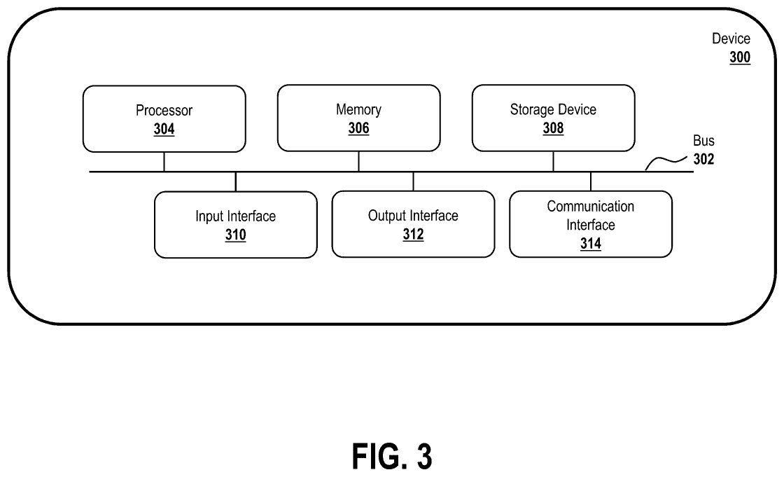

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a Charged-Coupled Device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD (Traffic Light Detection) data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Light Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum. In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e includes at least one device configured to be in communication with cameras 202a, LiDAR sensors 202b, radar sensors 202c, microphones 202d, autonomous vehicle compute 202f, safety controller 202g, and/or DBW (Drive-By-Wire) system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like), a server (e.g., a computing device including one or more central processing units, graphical processing units, and/or the like), and/or the like. In some embodiments, autonomous vehicle compute 202f is configured to implement autonomous vehicle software 400, described herein. In an embodiment, autonomous vehicle compute 202f is the same or similar to distributed computing architecture. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to make longitudinal vehicle motion, such as start moving forward, stop moving forward, start moving backward, stop moving backward, accelerate in a direction, decelerate in a direction or to make lateral vehicle motion such as performing a left turn, performing a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right. In other words, steering control system 206 causes activities necessary for the regulation of the y-axis component of vehicle motion.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like. Although brake system 208 is illustrated to be located in the near side of vehicle 200 in FIG. 2, brake system 208 may be located anywhere in vehicle 200.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102) and/or one or more devices of network 112 (e.g., one or more devices of a system of network 112). In some embodiments, one or more devices of vehicles 102 (e.g., one or more devices of a system of vehicles 102), and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some cases, processor 304 includes a processor (e.g., a central processing unit (CPU), a graphics processing unit (GPU), an accelerated processing unit (APU), and/or the like), a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a WiFi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

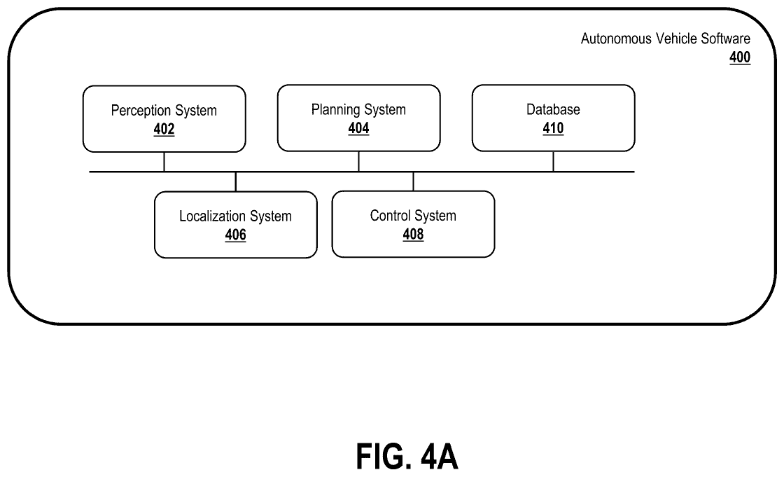

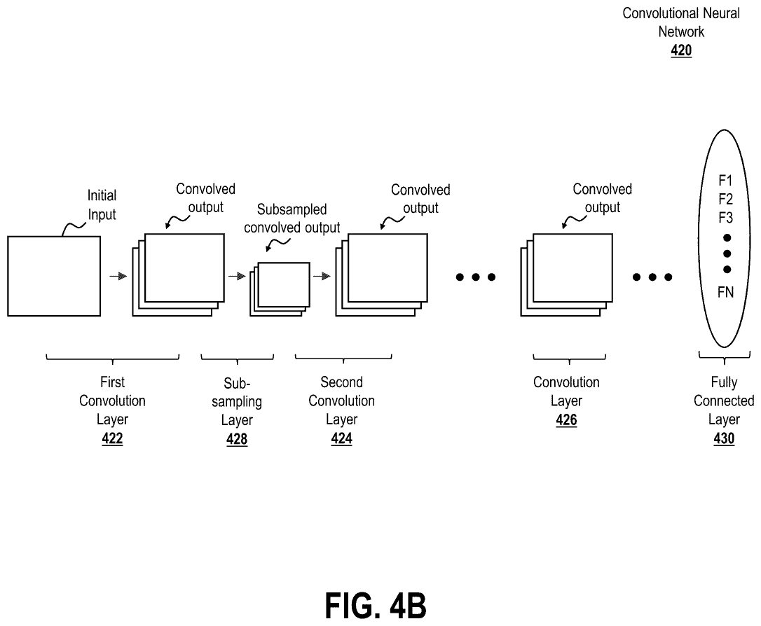

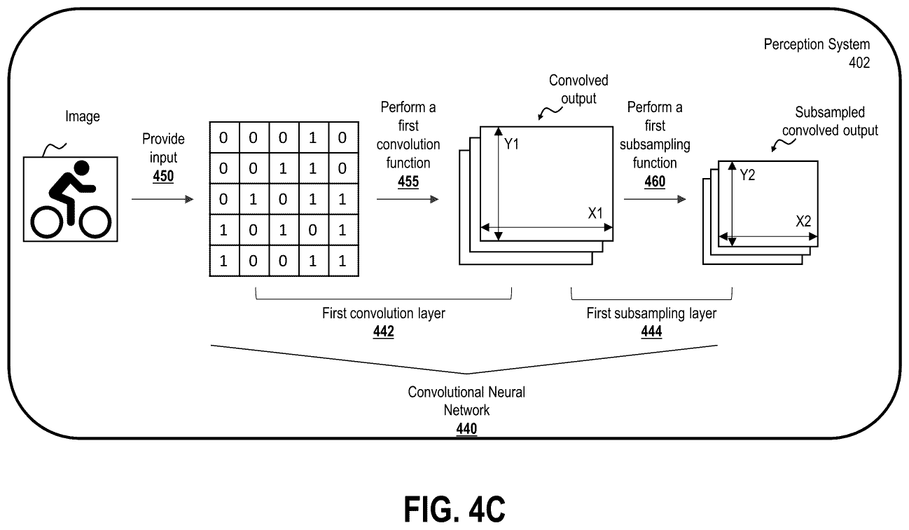

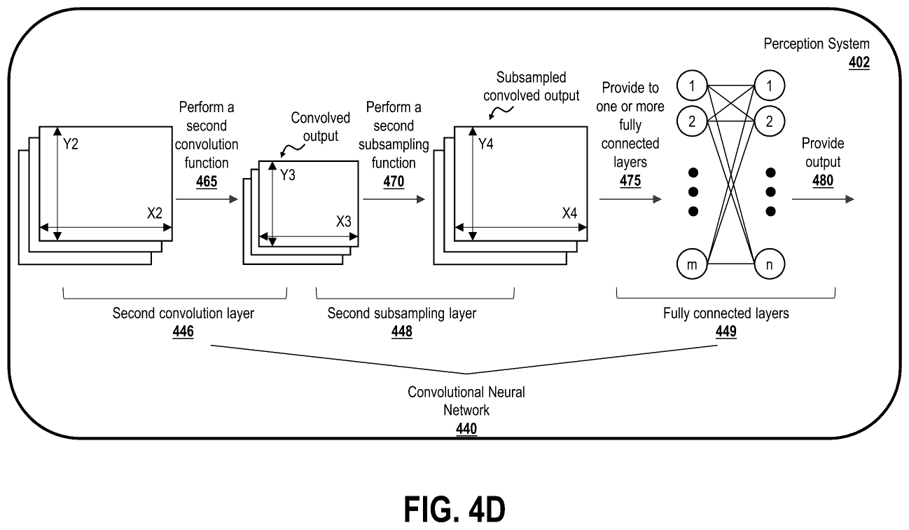

Referring now to FIG. 4A, illustrated is an example block diagram of an autonomous vehicle software 400 (sometimes referred to as an “AV stack”). As illustrated, autonomous vehicle software 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments, perception system 402, planning system 404, localization system 406, control system 408, and database 410 are included in one or more standalone systems (e.g., one or more systems that are the same as or similar to autonomous vehicle software 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle software 400 are implemented in software (e.g., in software instructions stored in memory), computer hardware (e.g., by microprocessors, microcontrollers, application-specific integrated circuits (ASICs), Field Programmable Gate Arrays (FPGAs), and/or the like), or combinations of computer software and computer hardware. It will also be understood that, in some embodiments, autonomous vehicle software 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In other words, planning system 404 may perform tactical function-related tasks that are required to operate vehicle 102 in on-road traffic. Tactical efforts involve maneuvering the vehicle in traffic during a trip, including but not limited to deciding whether and when to overtake another vehicle, change lanes, or selecting an appropriate speed, acceleration, deacceleration, etc. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. For example, control system 408 is configured to perform operational functions such as a lateral vehicle motion control or a longitudinal vehicle motion control. The lateral vehicle motion control causes activities necessary for the regulation of the y-axis component of vehicle motion. The longitudinal vehicle motion control causes activities necessary for the regulation of the x-axis component of vehicle motion. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like). An example of an implementation of a machine learning model is included below with respect to FIGS. 4B-4D.

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle software 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

Referring now to FIG. 4B, illustrated is a diagram of an implementation of a machine learning model. More specifically, illustrated is a diagram of an implementation of a convolutional neural network (CNN) 420. For purposes of illustration, the following description of CNN 420 will be with respect to an implementation of CNN 420 by perception system 402. However, it will be understood that in some examples CNN 420 (e.g., one or more components of CNN 420) is implemented by other systems different from, or in addition to, perception system 402 such as planning system 404, localization system 406, and/or control system 408. While CNN 420 includes certain features as described herein, these features are provided for the purpose of illustration and are not intended to limit the present disclosure.

CNN 420 includes a plurality of convolution layers including first convolution layer 422, second convolution layer 424, and convolution layer 426. In some embodiments, CNN 420 includes sub-sampling layer 428 (sometimes referred to as a pooling layer). In some embodiments, sub-sampling layer 428 and/or other subsampling layers have a dimension (i.e., an amount of nodes) that is less than a dimension of an upstream system. By virtue of sub-sampling layer 428 having a dimension that is less than a dimension of an upstream layer, CNN 420 consolidates the amount of data associated with the initial input and/or the output of an upstream layer to thereby decrease the amount of computations necessary for CNN 420 to perform downstream convolution operations. Additionally, or alternatively, by virtue of sub-sampling layer 428 being associated with (e.g., configured to perform) at least one subsampling function (as described below with respect to FIGS. 4C and 4D), CNN 420 consolidates the amount of data associated with the initial input.

Perception system 402 performs convolution operations based on perception system 402 providing respective inputs and/or outputs associated with each of first convolution layer 422, second convolution layer 424, and convolution layer 426 to generate respective outputs. In some examples, perception system 402 implements CNN 420 based on perception system 402 providing data as input to first convolution layer 422, second convolution layer 424, and convolution layer 426. In such an example, perception system 402 provides the data as input to first convolution layer 422, second convolution layer 424, and convolution layer 426 based on perception system 402 receiving data from one or more different systems (e.g., one or more systems of a vehicle that is the same as or similar to vehicle 102), a remote AV system that is the same as or similar to remote AV system 114, a fleet management system that is the same as or similar to fleet management system 116, a V2I system that is the same as or similar to V2I system 118, and/or the like). A detailed description of convolution operations is included below with respect to FIG. 4C.

In some embodiments, perception system 402 provides data associated with an input (referred to as an initial input) to first convolution layer 422 and perception system 402 generates data associated with an output using first convolution layer 422. In some embodiments, perception system 402 provides an output generated by a convolution layer as input to a different convolution layer. For example, perception system 402 provides the output of first convolution layer 422 as input to sub-sampling layer 428, second convolution layer 424, and/or convolution layer 426. In such an example, first convolution layer 422 is referred to as an upstream layer and sub-sampling layer 428, second convolution layer 424, and/or convolution layer 426 are referred to as downstream layers. Similarly, in some embodiments perception system 402 provides the output of sub-sampling layer 428 to second convolution layer 424 and/or convolution layer 426 and, in this example, sub-sampling layer 428 would be referred to as an upstream layer and second convolution layer 424 and/or convolution layer 426 would be referred to as downstream layers.

In some embodiments, perception system 402 processes the data associated with the input provided to CNN 420 before perception system 402 provides the input to CNN 420. For example, perception system 402 processes the data associated with the input provided to CNN 420 based on perception system 402 normalizing sensor data (e.g., image data, LiDAR data, radar data, and/or the like).

In some embodiments, CNN 420 generates an output based on perception system 402 performing convolution operations associated with each convolution layer. In some examples, CNN 420 generates an output based on perception system 402 performing convolution operations associated with each convolution layer and an initial input. In some embodiments, perception system 402 generates the output and provides the output as fully connected layer 430. In some examples, perception system 402 provides the output of convolution layer 426 as fully connected layer 430, where fully connected layer 430 includes data associated with a plurality of feature values referred to as F1, F2 . . . FN. In this example, the output of convolution layer 426 includes data associated with a plurality of output feature values that represent a prediction.

In some embodiments, perception system 402 identifies a prediction from among a plurality of predictions based on perception system 402 identifying a feature value that is associated with the highest likelihood of being the correct prediction from among the plurality of predictions. For example, where fully connected layer 430 includes feature values F1, F2, . . . FN, and F1 is the greatest feature value, perception system 402 identifies the prediction associated with F1 as being the correct prediction from among the plurality of predictions. In some embodiments, perception system 402 trains CNN 420 to generate the prediction. In some examples, perception system 402 trains CNN 420 to generate the prediction based on perception system 402 providing training data associated with the prediction to CNN 420.

Referring now to FIGS. 4C and 4D, illustrated is a diagram of example operation of CNN 440 by perception system 402. In some embodiments, CNN 440 (e.g., one or more components of CNN 440) is the same as, or similar to, CNN 420 (e.g., one or more components of CNN 420) (see FIG. 4B).

At step 450, perception system 402 provides data associated with an image as input to CNN 440 (step 450). For example, as illustrated, perception system 402 provides the data associated with the image to CNN 440, where the image is a greyscale image represented as values stored in a two-dimensional (2D) array. In some embodiments, the data associated with the image may include data associated with a color image, the color image represented as values stored in a three-dimensional (3D) array. Additionally, or alternatively, the data associated with the image may include data associated with an infrared image, a radar image, and/or the like.

At step 455, CNN 440 performs a first convolution function. For example, CNN 440 performs the first convolution function based on CNN 440 providing the values representing the image as input to one or more neurons (not explicitly illustrated) included in first convolution layer 442. In this example, the values representing the image can correspond to values representing a region of the image (sometimes referred to as a receptive field). In some embodiments, each neuron is associated with a filter (not explicitly illustrated). A filter (sometimes referred to as a kernel) is representable as an array of values that corresponds in size to the values provided as input to the neuron. In one example, a filter may be configured to identify edges (e.g., horizontal lines, vertical lines, straight lines, and/or the like). In successive convolution layers, the filters associated with neurons may be configured to identify successively more complex patterns (e.g., arcs, objects, and/or the like).

In some embodiments, CNN 440 performs the first convolution function based on CNN 440 multiplying the values provided as input to each of the one or more neurons included in first convolution layer 442 with the values of the filter that corresponds to each of the one or more neurons. For example, CNN 440 can multiply the values provided as input to each of the one or more neurons included in first convolution layer 442 with the values of the filter that corresponds to each of the one or more neurons to generate a single value or an array of values as an output. In some embodiments, the collective output of the neurons of first convolution layer 442 is referred to as a convolved output. In some embodiments, where each neuron has the same filter, the convolved output is referred to as a feature map.

In some embodiments, CNN 440 provides the outputs of each neuron of first convolutional layer 442 to neurons of a downstream layer. For purposes of clarity, an upstream layer can be a layer that transmits data to a different layer (referred to as a downstream layer). For example, CNN 440 can provide the outputs of each neuron of first convolutional layer 442 to corresponding neurons of a subsampling layer. In an example, CNN 440 provides the outputs of each neuron of first convolutional layer 442 to corresponding neurons of first subsampling layer 444. In some embodiments, CNN 440 adds a bias value to the aggregates of all the values provided to each neuron of the downstream layer. For example, CNN 440 adds a bias value to the aggregates of all the values provided to each neuron of first subsampling layer 444. In such an example, CNN 440 determines a final value to provide to each neuron of first subsampling layer 444 based on the aggregates of all the values provided to each neuron and an activation function associated with each neuron of first subsampling layer 444.

At step 460, CNN 440 performs a first subsampling function. For example, CNN 440 can perform a first subsampling function based on CNN 440 providing the values output by first convolution layer 442 to corresponding neurons of first subsampling layer 444. In some embodiments, CNN 440 performs the first subsampling function based on an aggregation function. In an example, CNN 440 performs the first subsampling function based on CNN 440 determining the maximum input among the values provided to a given neuron (referred to as a max pooling function). In another example, CNN 440 performs the first subsampling function based on CNN 440 determining the average input among the values provided to a given neuron (referred to as an average pooling function). In some embodiments, CNN 440 generates an output based on CNN 440 providing the values to each neuron of first subsampling layer 444, the output sometimes referred to as a subsampled convolved output.

At step 465, CNN 440 performs a second convolution function. In some embodiments, CNN 440 performs the second convolution function in a manner similar to how CNN 440 performed the first convolution function, described above. In some embodiments, CNN 440 performs the second convolution function based on CNN 440 providing the values output by first subsampling layer 444 as input to one or more neurons (not explicitly illustrated) included in second convolution layer 446. In some embodiments, each neuron of second convolution layer 446 is associated with a filter, as described above. The filter(s) associated with second convolution layer 446 may be configured to identify more complex patterns than the filter associated with first convolution layer 442, as described above.

In some embodiments, CNN 440 performs the second convolution function based on CNN 440 multiplying the values provided as input to each of the one or more neurons included in second convolution layer 446 with the values of the filter that corresponds to each of the one or more neurons. For example, CNN 440 can multiply the values provided as input to each of the one or more neurons included in second convolution layer 446 with the values of the filter that corresponds to each of the one or more neurons to generate a single value or an array of values as an output.

In some embodiments, CNN 440 provides the outputs of each neuron of second convolutional layer 446 to neurons of a downstream layer. For example, CNN 440 can provide the outputs of each neuron of first convolutional layer 442 to corresponding neurons of a subsampling layer. In an example, CNN 440 provides the outputs of each neuron of first convolutional layer 442 to corresponding neurons of second subsampling layer 448. In some embodiments, CNN 440 adds a bias value to the aggregates of all the values provided to each neuron of the downstream layer. For example, CNN 440 adds a bias value to the aggregates of all the values provided to each neuron of second subsampling layer 448. In such an example, CNN 440 determines a final value to provide to each neuron of second subsampling layer 448 based on the aggregates of all the values provided to each neuron and an activation function associated with each neuron of second subsampling layer 448.

At step 470, CNN 440 performs a second subsampling function. For example, CNN 440 can perform a second subsampling function based on CNN 440 providing the values output by second convolution layer 446 to corresponding neurons of second subsampling layer 448. In some embodiments, CNN 440 performs the second subsampling function based on CNN 440 using an aggregation function. In an example, CNN 440 performs the first subsampling function based on CNN 440 determining the maximum input or an average input among the values provided to a given neuron, as described above. In some embodiments, CNN 440 generates an output based on CNN 440 providing the values to each neuron of second subsampling layer 448.

At step 475, CNN 440 provides the output of each neuron of second subsampling layer 448 to fully connected layers 449. For example, CNN 440 provides the output of each neuron of second subsampling layer 448 to fully connected layers 449 to cause fully connected layers 449 to generate an output. In some embodiments, fully connected layers 449 are configured to generate an output associated with a prediction (sometimes referred to as a classification). The prediction may include an indication that an object included in the image provided as input to CNN 440 includes an object, a set of objects, and/or the like. In some embodiments, perception system 402 performs one or more operations and/or provides the data associated with the prediction to a different system, described herein.

A system-on-chip (SoC) refers to an integrated circuit (or a “chip”) that integrates all or most components of a computing system and/or other electronic systems. Such components include, for example, a central processing unit (CPU), input/output (I/O) devices, memory, storage, etc. Other components may include various communication components, graphics processing units (GPU), etc. These components may be integrated on a single substrate or microchip. Various digital, analog, mixed-signal, and/or radio frequency (RF) signal processing functions, etc. may be incorporated as well. A SoC can integrate a microcontroller, a microprocessor and/or one or more processor cores with a GPU, Wi-Fi and/or cellular network radio components, etc. Similar to how a microcontroller integrates a microprocessor with peripheral circuits and memory, a SoC can be seen as integrating a microcontroller with even more advanced peripherals. For an overview of integrating system components, see system integration.

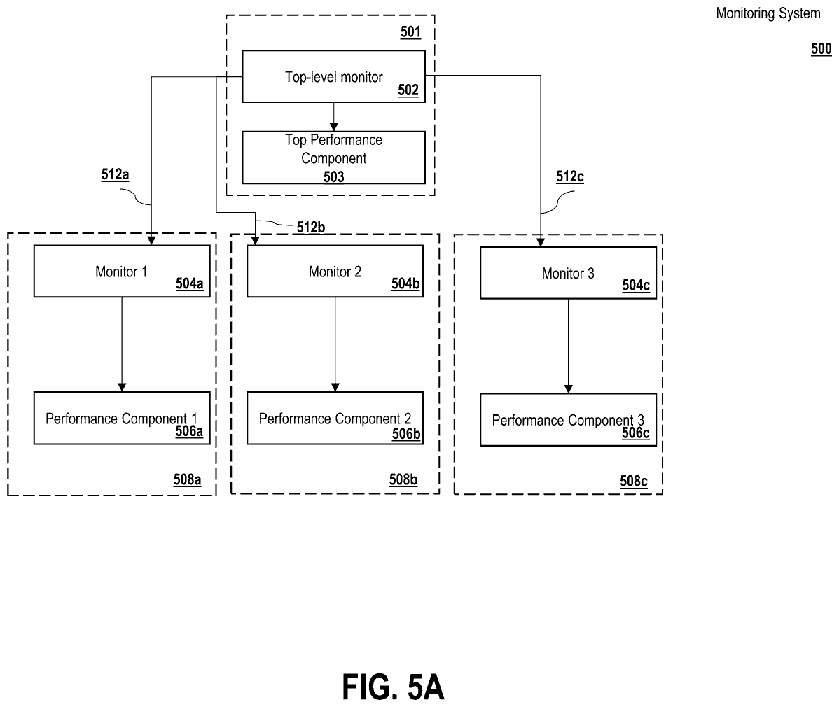

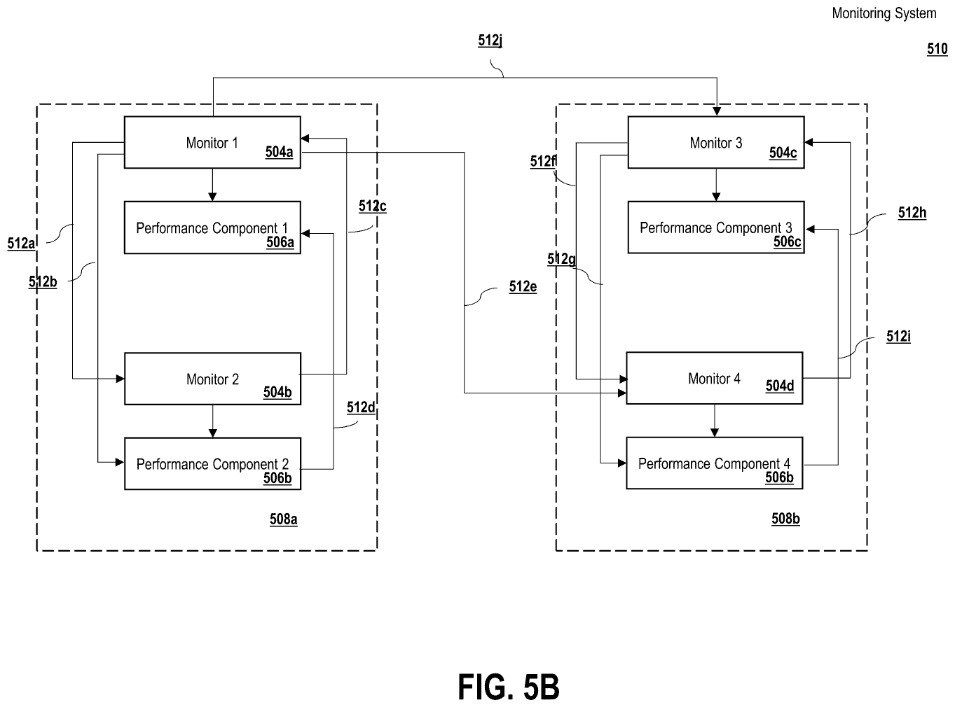

FIGS. 5A and 5B illustrate an example monitoring systems 500, 510 that may be used for monitoring one or more processing cores. FIG. 5A illustrates the example monitoring system 500 as including one or more system-on-chips, dies, and/or integrated circuits 501, 508(a, b, c). Each SoC 501, 508 may include one or more processing components. The example monitoring system 500 can be semi-hierarchically structured. For example, the SoC 501 may include a top level monitoring processor (“top-level monitor”) 502 and a top level performance core processor (“top performance component”) 503. SoC 508a may include a monitoring processor 1 (“monitor 1”) 504a and a performance core processor 1 (“performance component 1”) 506a. SoC 508b may include a monitoring processor 2 (“monitor 2”) 504b and a performance core processor 2 (“performance component 2”) 506b. SoC 508c may include a monitoring processor 3 (“monitor 3”) 504c and a performance core processor 3 (“performance component 3”) 506c. As can be understood, the example monitoring system 500 may include other monitors 504 and performance components 506.

Any monitoring processor 504a, 504b, 504c can include a monitoring processor cluster, such as clusters including multiple distinct chiplets that can be packaged onto a common chassis. The monitoring processor cluster can increase the reliability of the example monitoring system 500, to enable continuation of operations. Each monitor 504a, 504b, 504c may be configured to monitor operation and/or execution of one or more processes by a performance component 506 that is assigned for monitoring to that monitor (e.g., monitor 1 504a monitors performance component 506a). In some embodiments, one or more monitors (e.g., monitor 504c) of the monitors 504a, 504b, 504c can be a backup monitor that can perform the operations of other (failing) monitors included in the example monitoring system 500. Each monitor 504a, 504b, 504c may be configured as a high-reliability core that is directly connected to the respective performance component 506a, 506b, 506c.

In some embodiments, the top-level monitor 502 may be configured to monitor execution of monitoring processes by each individual monitor 504. The top-level monitor 502 may be disposed on a separate monitoring core SoC 501 (similar to each of the individual monitors 504) arranged in a semi-hierarchical fashion with the lower level monitors 504. Each individual monitor 504 may be configured to be connected, by communication links 512a, 512b, 512c (including on-die interconnections, wiring and/or various buses) to the top-level monitor 502. Further, each such monitor 504a, 504b, 504c may be configured for detection of errors that may be occurring during execution of one or more processes by the performance components 506a, 506b, 506c and/or connected monitors 504a, 504b, 504c.

In the example monitoring system 500 shown in FIG. 5A, monitoring processors 504a, 504b, 504c and/or performance core processors 506a, 506b, 506c may be positioned on common chips (or dies) 508a, 508b, 508c. The clustered positioning of processors 504a, 504b, 504c and/or cores, monitoring of performance core processors can optimize execution of one or more actions performed by the performance core processors, including actions executed in response to requests from monitoring processors, such as redirection of operations. The clustering of two or more performance core and monitoring processors on common chips (or dies) can optimize general purpose processing, while preserving the underlying computational architecture, thereby making monitoring more effective.

FIG. 5B illustrates the example monitoring system 510 as including one or more system-on-chips, dies, and/or integrated circuits 508a, 508b. Each SoC 508a, 508b may include multiple processing components. The example monitoring system 510 can be hierarchically structured and/or peer to peer and/or cyclic structured. For example, the SoC 508a may include monitoring processors 1, 2 (“monitor 1” and “monitor 2”) 504a, 504b and performance core processors 1, 2 (“performance component 1” and “performance component 2”) 506a, 506b. SoC 508b may include monitoring processors 3, 4 (“monitor 3” and “monitor 4”) 504c, 504d and performance core processors 3, 4 (“performance component 3” and “performance component 4”) 506c, 506d. As can be understood, the example monitoring system 510 may include other monitors 504 and performance components 506.

Each monitor 504a, 504b, 504c, 504d may be configured to monitor operation and/or execution of one or more processes by one or more performance components 506a, 506b, 506c, 506d that are assigned for monitoring. In some embodiments, one or more monitors (e.g., monitor 504c) of the monitors 504a, 504b, 504c, 504d can be a backup monitor that can perform the operations of other (failing) monitors included in the example monitoring system 510. Each monitor 504a, 504b, 504c, 504d may be configured as a high-reliability core that is directly connected to the respective performance component 506a, 506b, 506c, 506d. Each individual monitor 504a, 504b, 504c, 504d may be configured to be connected, by communication links 512a-512j (including on-die interconnections, wiring, and/or various buses) to other monitors 504a, 504b, 504c, 504d and/or one or more performance components 506a, 506b, 506c, 506d that are within their respective system-on-chips, dies, and/or integrated circuits 508a, 508b or are included in an external system-on-chips, dies, and/or integrated circuits 508a, 508b. For example, a selected monitor 504a can monitor multiple performance components 506a, 506b and multiple other monitors 504a, 504b, 504c, 504d that also monitor other performance components and monitor(s), defining a cyclic monitoring system that ensures that all components of the example monitoring system 510 are monitored and can be substituted, in case of error detection. The described embodiment can be arranged to retain full monitoring coverage of all performance components 506a, 506b, 506c, 506d in the presence of a fault or error in any single monitoring device 504a, 504b, 504c, 504d.

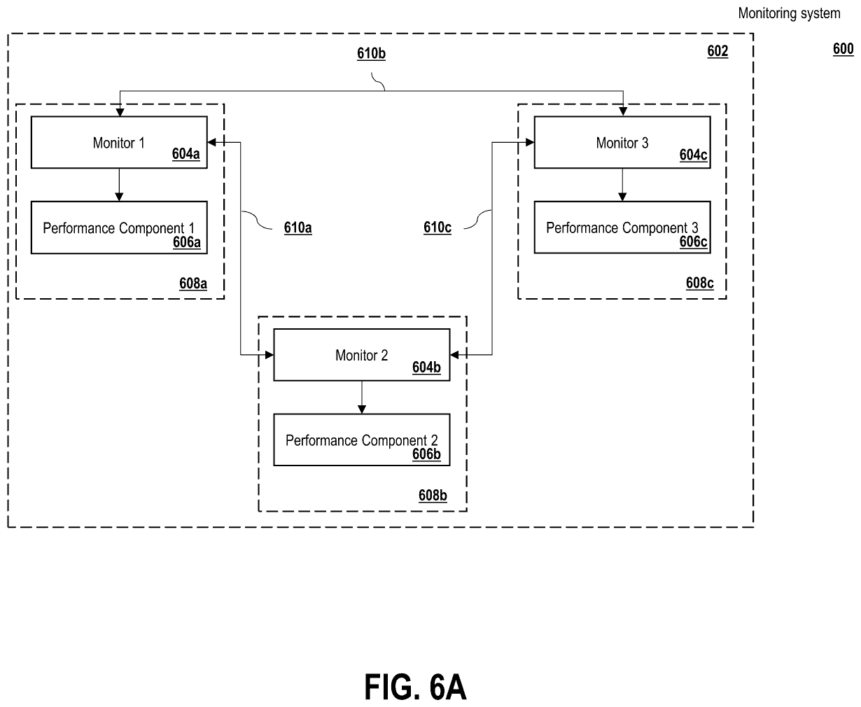

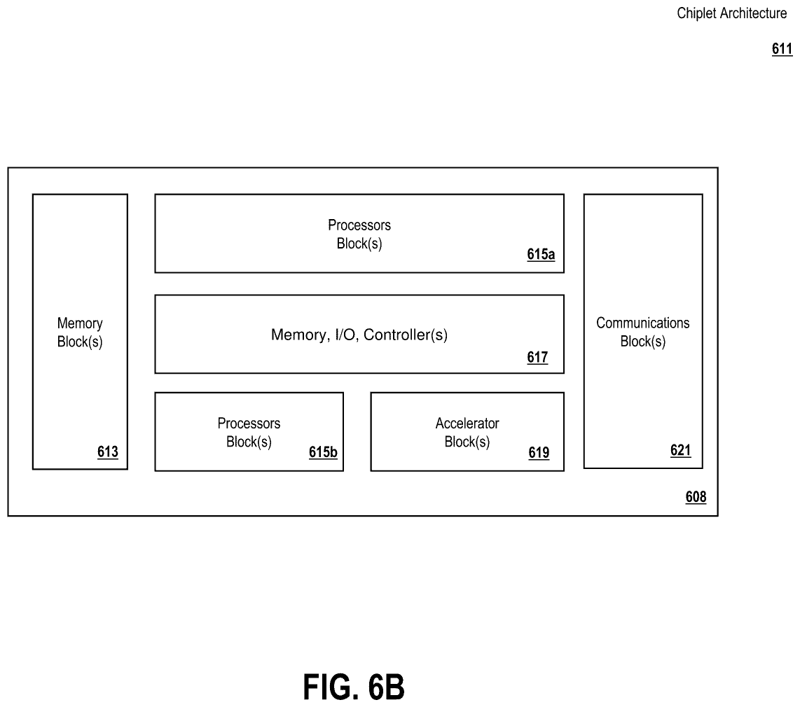

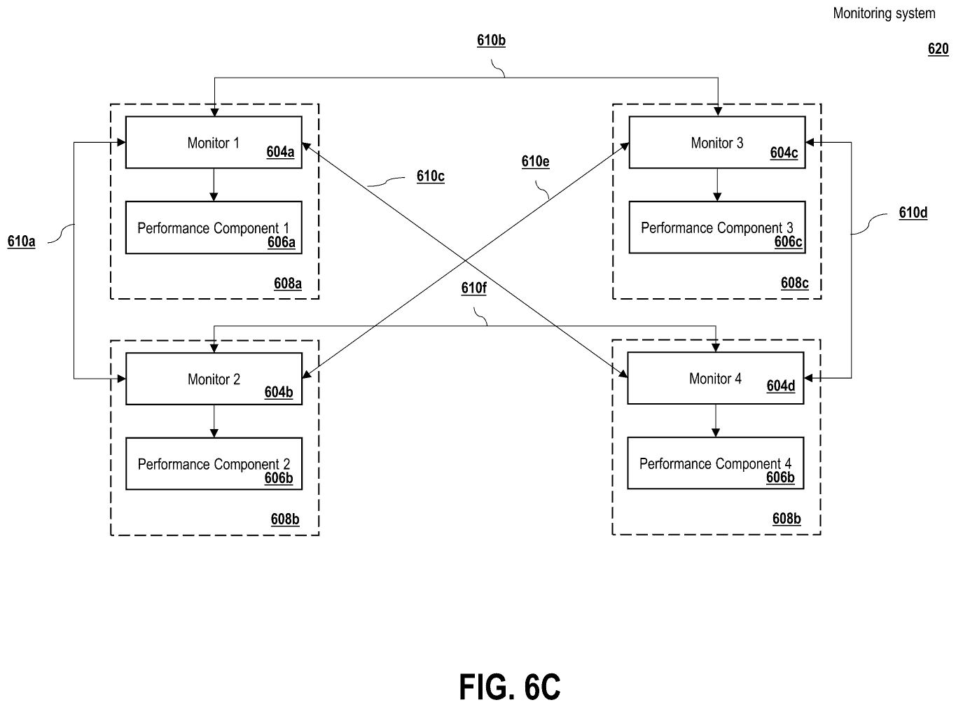

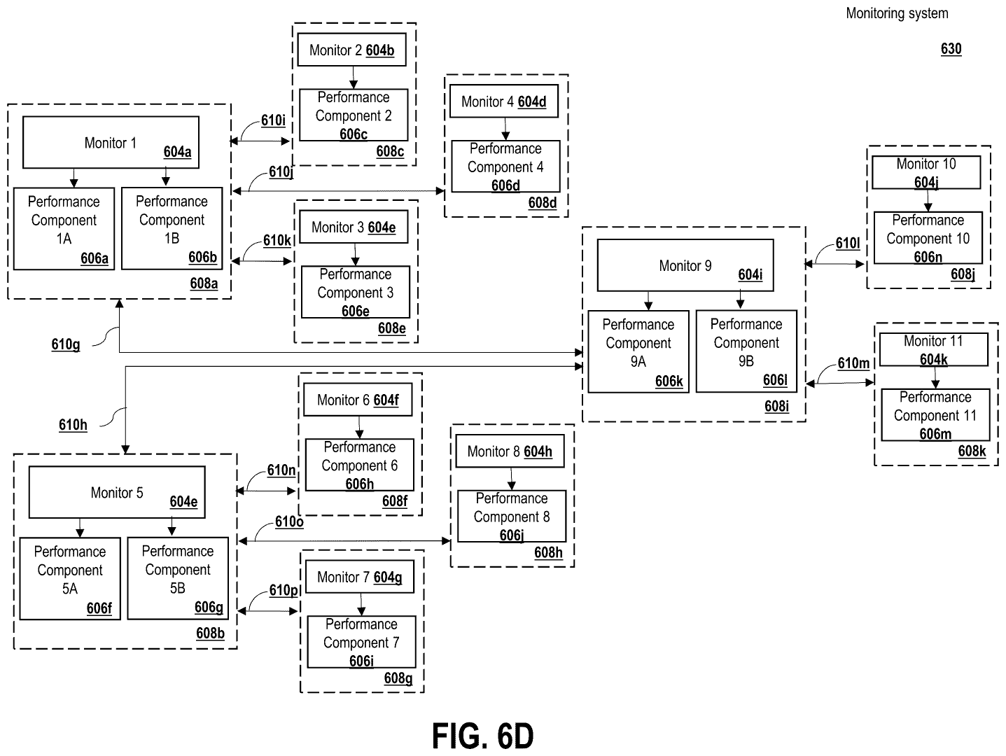

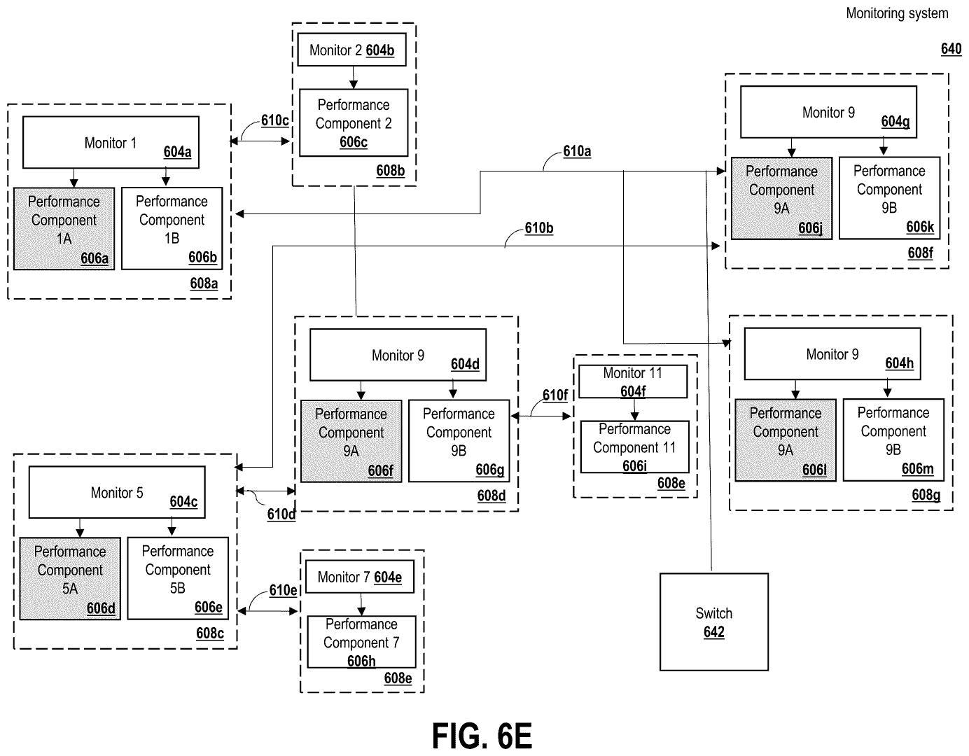

FIG. 6A illustrates an example monitoring system 600 that may be used for monitoring one or more processing cores, according to some implementations of the current subject matter. The example monitoring system 600 may be configured to resolve the deficiencies of disaggregated chiplets, by positioning one or more monitoring core processors 604a, 604b, 604c and one or more performance core processors 606a, 606b, 606c a on a single chiplet 602, chip, and/or die, thereby optimizing the processing that may be required for performing of the monitoring functions. The use of chiplet-based architectures may allow use of on-die interconnect 610a, 610b, 610c instead of external connections for monitoring, thereby reducing latency. Multiple chiplets may also be packaged on the common chiplet 602, chip, and/or die, thereby providing low latency, and built-in fault tolerance. Fault tolerance may be achieved by monitoring core processors in-addition to monitoring the performance core processors, performing monitoring of other monitoring core processors either in a paired fashion (e.g., each monitoring core processors monitors another monitoring core processor), a dual-peer monitoring (e.g., each monitoring core processor monitors 2 or more other monitoring core processors), a cyclic monitoring (e.g., each monitoring core processor monitor all other monitoring core processors in a cyclic fashion), and/or any other ways of monitoring.

With continuous reference to FIG. 6A, the example monitoring system 600 may include one or more chiplets, chips and/or dies 608(a, b, c) that may be communicatively coupled to one another via one or more communication links 610(a, b, c). As can be understood, there can be any number of chiplets, chips and/or dies 608, each of which may be communicatively coupled to one, several and/or all other chiplets, chips and/or dies 608. For instance, in an autonomous vehicle system, the chiplets, chips and/or dies 608 may be associated with various sensors, components, etc. of the vehicle (e.g., an autonomous vehicle shown or referred to in FIGS. 1-4).

Each of the chiplets, chips and/or dies 608 may be configured to incorporate a monitoring core processor 604 and a performance core processor/component 606. For instance, the chiplet, chip and/or die 608a may include monitoring core processor 1 604a and performance core processor 1 606a; the chiplet, chip and/or die 608b may include monitoring core processor 2 604b and performance core processor 2 606b; and the chiplet, chip and/or die 608c may include monitoring core processor 3 604c and performance core processor 3 606c. Moreover, the monitoring core processors 604 may be communicatively coupled to one another using communication links 610 to allow for monitoring core processors to monitor each other's monitoring operations. For example, the monitoring core processor 604a may be communicatively coupled to the monitoring core processor 604b using a communication link 610a and may be further communicatively coupled to the monitoring core processor 604c using a communication link 610b. Likewise, monitoring core processor 604b may be coupled to the monitoring core processor 604c using a communication link 610c. Communication links 610 may be single two-way communication links and/or may be separate links communicatively coupling respective monitoring core processors 604.

In addition to monitoring other monitoring core processors, each monitoring core processor 604 may be configured to monitor execution of various operations, actions, processes, etc. by a corresponding performance core processor 606 (e.g., processor 604a monitors processor 606a, etc.). The monitoring and performance core processors may be communicatively coupled using a peripheral component interconnect express (PCIe), a universal chiplet interconnect express (UCIe), and/or any other connections. The monitoring of either the monitoring core processors and/or performance core processors may be performed using any desired methods, such as, for example, for example by exchanging encrypted keep-alive messages using known interconnect technologies, such as, PCIe, UCIe, and/or other protocols. Alternatively, or in addition to, each monitoring core processor 604 may request one or more operational status updates from one, several, and/or all other monitoring core processor 604. Such status updates may be provided in any desired format. Monitoring, transmission of status updates, heartbeat messages, etc. may be performed using any desired schedule, e.g., periodic, at predetermined time, upon occurrence and/or detection of errors in one or more performance core processors and/or monitoring core processors.

Monitoring of performance core processors and other monitors may ensure that any faults, errors, etc. that may occur during operation, testing, etc. of an autonomous vehicle and its systems, components, sensors, etc. are reported and handled quickly and with low latency. The example monitoring system 600 may be configured to allow integrated on-chip/die monitoring core processors 604 to monitor performance core processors 606, which, in turn, may provide for easy and low-latency access to all monitoring-relevant signals from all performance core processors 606. Further, monitoring of monitoring core processors 604 may be performed by neighboring monitoring core processors 604 in any desired pattern (e.g. paired, cyclic). Additionally, each individual monitoring core processor 604 may be configured to provide guarantees for high-confidence detection of errors. The guarantees for high-confidence detection of errors, along with peer monitoring by other monitoring core processors 604, may allow for a quick reaction to any loss and/or error on any individual integrated chip 608 without a need for an external monitoring core (e.g., such as a top-level monitor 502 shown in FIG. 5A).

In some embodiments, the monitoring core processors 604 may be configured to analyze any monitoring signals that have been detected by and/or transmitted to them from other monitoring core processors 604 (and/or from the corresponding performance core processors 606). Based on the analysis of such signals, the monitoring core processors 604 may be configured to generate a response, which may be used to, for example, to alter operation of one or more systems, components, sensors, etc. of the autonomous vehicle (e.g., vehicle shown in and/or referred to in FIGS. 1-4). For example, the monitoring core processors 604 may be configured to down-weight and/or ignore any and/or all of such signals associated with one or more affected systems, components, sensors, etc. while allowing other processes (e.g., monitoring, performance, etc.) to continue safely. Alternatively, or in addition to, responses to such monitoring signals may cause halting operations of one or more systems, components, sensors, etc. or the initiation of new processes or operations, or the reconfiguration or reallocation of multiple operations, while at the same time ensuring safety of operation of the autonomous vehicle's other systems, components, sensors, or other devices included in or coupled to the vehicle. In some embodiments, all monitoring core processors 604 may be configured to have access to trigger any fault/error response based on the received signals from one or more other monitoring core processors 604. A superset of requested fault mitigation responses that may be programmed into the monitoring system of the vehicle (e.g., vehicle shown in FIGS. 1-4) may be configured to prevail.

In some embodiments, peer monitoring by monitoring core processors 604 may provide various levels fault tolerance where monitoring core processors 604 may be configured to maintain peer monitoring coverage even if one of the monitoring core processors 604 has failed. For example, the monitoring core processors 604a and/or 604c may continue monitoring operation of the performance core processor 606b even if its corresponding monitoring core processor 604b, that has been assigned to it for monitoring, has failed.

FIG. 6B illustrates another example chiplet architecture 611. The chiplet architecture 611 may be embodied as any type of engine, device, or collection of devices capable of performing various compute functions, as described with reference to FIGS. 1-4 and 7. The chiplet architecture 611 may include a packaging substrate and/or a platform 608, on which one or more memory blocks 613, one or more processor block(s) 615(a, b), one or more memory, I/O, controller(s) 617, one or more accelerator block(s) 619, and one or more communication block(s) 621 may be positioned/packaged.

The packaging substrate and/or a platform 608 can include a silicon based or an epoxy-based laminate substrate. The packaging substrate and/or a platform 608 may include other suitable types of substrates in other embodiments. The chiplet architecture 611 can be connected to other electrical devices via the communication block(s) 621. The communication block(s) 621 may be coupled to a surface of the packaging substrate and/or a platform 608 to route electrical signals to other electrical devices, such as a motherboard, other chipset, or a multi-chip module.

The memory blocks 613 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM). In some embodiments, the memory blocks 613 can include a block addressable memory device, such as those based on NAND or NOR technologies. The memory block 613 may also include a three-dimensional crosspoint memory device (e.g., Intel 3D XPoint™ memory), or other byte addressable write-in-place nonvolatile memory devices. The memory blocks 613 may refer to the die itself and/or to a packaged memory product. In some examples, 3D crosspoint memory (e.g., Intel 3D XPoint™ memory) may comprise a transistor-less stackable cross point architecture in which memory cells sit at the intersection of word lines and bit lines and are individually addressable and in which bit storage is based on a change in bulk resistance. In some examples, all or a portion of the memory blocks 613 may be integrated into the processor block(s) 615(a, b). The memory blocks 613 may store various software and data used during vehicle operation such as one or more applications, data operated on by the application(s), libraries, and drivers.

The processor block(s) 615(a, b) may be embodied as any type of processor capable of performing the functions described herein (e.g., executing an application). For example, the processor block(s) 615(a, b) may be embodied as a multi-core processor(s), a microcontroller, or other processor or processing/controlling circuit. In some examples, the processor block(s) 615(a, b) may be embodied as, include, or be coupled to an FPGA, an application specific integrated circuit (ASIC), reconfigurable hardware or hardware circuitry, or other specialized hardware to facilitate performance of the functions described herein. For example, the processor block(s) 615(a, b) may include one or more processors that may be designed to perform one or more functionalities (e.g., as discussed herein, monitoring of performance core processors, and/or performing various functions, etc.).

The memory, I/O, controller(s) 617 may be embodied as circuitry and/or components to facilitate input/output operations with the processor block(s) 615(a, b), the memory block 613 and other components of the chiplet architecture 611. For example, the memory, I/O, controller(s) 617 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the memory, I/O, controller(s) 617 may form a portion of a system-on-a-chip (SoC) and be incorporated, along with one or more of the processor block(s) 615(a, b), the memory block 613, and other components of the chiplet architecture 611.

The accelerator block(s) 619 can include hardware, such as accelerator components configured to provide coordination of acceleration resources available for functions and distribution of functions between chiplet architecture 611 (including “warm” chiplet architecture 611, already deployed or operating, versus “cold” which require deployment or configuration).

The communication block(s) 621 may be embodied as any communication circuit, device, or collection thereof, capable of enabling communications over a network between the example chiplet architecture 611 and another compute device (e.g., another example chiplet architecture 611). The communication block(s) 621 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fie, a wireless wide area network protocol, Ethernet, Bluetooth®, etc.) to effect the communication. The communication block(s) 621 can includes a network interface controller (NIC), which may also be referred to as a host fabric interface (HFI). The NIC may be embodied as one or more add-in-boards, daughter cards, network interface cards, controller chips, chipsets, or other devices that may be used by the communication block(s) 621 to connect with another compute device (e.g., chiplet architecture 611). In some examples, the NIC may be embodied as part of a system-on-a-chip (SoC) that includes one or more processors, or included on a multichip package that also contains one or more processors. In some examples, the NIC may include a local processor (not shown) and/or a local memory (not shown) that are both local to the NIC. The local processor of the NIC may be capable of performing one or more of the functions of the chiplet architecture 611 described herein. Additionally or alternatively, in such examples, the local memory of the NIC may be integrated into one or more components of the client compute node at the board level, socket level, chip level, and/or other levels.

FIG. 6C illustrates an example monitoring system 620 that may be used for monitoring one or more processing cores, according to some implementations of the current subject matter. The example monitoring system 620 may be configured to perform monitoring of monitoring core processors in a dual and/or pair-wise and/or cyclic and/or multi-monitor fashion. The example monitoring system 620 may be configured to be similar to and/or include at least a portion of the example monitoring systems 600, 611 shown in FIGS. 6A and 6B. Similar to system 600, in the example monitoring system 620, one or more monitoring core processors and one or more performance core processors may be positioned on a single chiplet, chip and/or die, thereby reducing the time, processing, bandwidth, etc. that may be required for performing of the monitoring functions. As shown in FIG. 6C, the example monitoring system 620 may include monitoring core processors 604a, 604b, 604c, 604d, performance core processors 606a, 606b, 606c, 606d, one or more chiplets, chips and/or dies 608(a, b, c, d), and communication links 610a, 610b, 610c, 610d, 610e, 610f.

The chiplets, chips and/or dies 608(a, b, c, d) may be similar to the chiplet architecture 611 described with reference to FIG. 6B. The chiplets, chips and/or dies 608(a, b, c, d) can be communicatively coupled to one another via one or more communication links 610(a, b, c, d). As can be understood, there can be any number of chiplets, chips and/or dies 608, each of which may be communicatively coupled to one, several and/or all other chiplets, chips and/or dies 608. Similar to system 600, in an autonomous vehicle system, the chiplets, chips and/or dies 608 may be associated with various sensors, components, etc. of the vehicle (e.g., an autonomous vehicle shown or referred to in FIGS. 1-4).

Each of the chiplets, chips and/or dies 608 may be configured to incorporate a monitoring core processor 604 and a performance core processor/component 606. For instance, the chiplet, chip and/or die 608a may include monitoring core processor 1 604a and performance core processor 1 606a; the chiplet, chip and/or die 608b may include monitoring core processor 2 604b and performance core processor 2 606b; the chiplet, chip and/or die 608c may include monitoring core processor 3 604c and performance core processor 3 606c; and the chiplet, chip and/or die 608d may include monitoring core processor 4 604d and performance core processor 4 606d. The monitoring core processors 604 may be communicatively coupled to one another using communication links 610 to allow for monitoring core processors to monitor each other's monitoring operations. For example, the monitoring core processor 604a may be communicatively coupled to the monitoring core processor 604b using a communication link 610a, may be communicatively coupled to the monitoring core processor 604c using a communication link 610b, and may be communicatively coupled to the monitoring core processor 604d using a communication link 610c. Similarly, other monitoring core processor 604b, 604c, and 604d may be communicatively coupled to other the monitoring core processors. As can be understood, monitoring core processors 604 may be selectively communicatively coupled to other monitoring core processors 604, i.e., it is not necessary that each monitoring core processor 604 is communicatively coupled to all other monitoring core processors 604. Communication links 610 may be single two-way communication links and/or may be separate links communicatively coupling respective monitoring core processors 604.

In addition to monitoring other monitoring core processors, each monitoring core processor 604 may be configured to monitor execution of various operations, actions, processes, etc. by a corresponding performance core processor 606 (e.g., processor 604a monitors processor 606a, etc.). The monitoring and performance core processors may be communicatively coupled using a peripheral component interconnect express (PCIe), a universal chiplet interconnect express (UCIe), and/or any other connections. The monitoring of either the monitoring core processors and/or performance core processors may be performed using any desired methods, such as, for example, for example by exchanging encrypted keep-alive messages using known interconnect technologies, such as, PCIe, UCIe, and/or other protocols. Alternatively, or in addition to, each monitoring core processor 604 may request one or more operational status updates from one, several, and/or all other monitoring core processor 604. Such status updates may be provided in any desired format. Monitoring, transmission of status updates, heartbeat messages, etc. may be performed using any desired schedule, e.g., periodic, at predetermined time, upon occurrence and/or detection of errors in one or more performance core processors and/or monitoring core processors.

Monitoring of performance core processors and other monitors may ensure that any faults, errors, etc. that may occur during operation, testing, etc. of an autonomous vehicle and its systems, components, sensors, etc. are reported and handled quickly and with low latency. Similar to system 600 shown in FIG. 6A, the example monitoring system 620 may be configured to allow integrated on-chip/die monitoring core processors 604 to monitor performance core processors 606, which, in turn, may provide for easy and low-latency access to all monitoring-relevant signals from all performance core processors 606. The monitoring of monitoring core processors 604 may be performed by neighboring monitoring core processors 604 in any desired execution pattern (e.g., dual, paired, cyclic, etc.). The execution pattern of monitoring cores monitoring respective neighbors may be arranged such that full monitoring coverage is maintained in the presence of any single fault, or in the presence of multiple faults in multiple monitoring cores, which lead to the loss of operational functionality of those monitoring cores. Each individual monitoring core processor 604 may be configured to provide guarantees for high-confidence detection of errors, and may allow for a fast reaction to any loss and/or error on any individual integrated chip 608.

In some embodiments, the monitoring core processors 604 may be configured to analyze any monitoring signals that have been detected by and/or transmitted to them from other monitoring core processors 604 (and/or from the corresponding performance core processors 606). Based on the analysis of such signals, the monitoring core processors 604 may be configured to generate a response, which may be used to, for example, to alter operation of one or more systems, components, sensors, etc. of the autonomous vehicle (e.g., vehicle shown in and/or referred to in FIGS. 1-4). For example, the monitoring core processors 604 may be configured to down-weight and/or ignore any and/or all of such signals associated with one or more affected systems, components, sensors, etc. while allowing other processes (e.g., monitoring, performance, etc.) to continue safely. Alternatively, or in addition to, responses to such monitoring signals may cause halting operations of one or more systems, components, sensors, etc. while at the same time ensuring safety of operation of the autonomous vehicle's other systems, components, sensors, etc. In some embodiments, all monitoring core processors 604 may be configured to have access to trigger any fault/error response based on the received signals from one or more other monitoring core processors 604. A superset of requested fault mitigation responses that may be programmed into the monitoring system of the vehicle (e.g., vehicle shown in FIGS. 1-4) may be configured to prevail.

In some embodiments, peer monitoring by monitoring core processors 604 may provide various levels of fault tolerance, where monitoring core processors 604 may be configured to maintain peer monitoring coverage even if one of the monitoring core processors 604 has failed. For example, the monitoring core processors 604a and/or 604c and/or 604d may continue monitoring operation of the performance core processor 606b even if its corresponding monitoring core processor 604b, that has been assigned to it for monitoring, has failed.

FIG. 6D illustrates an example monitoring system 630 that may be used for monitoring one or more processing cores, according to some implementations of the current subject matter. The example monitoring system 630 may be configured to perform monitoring of monitoring core processors in a dual and/or pair-wise and/or cyclic and/or multi-monitor fashion. The example monitoring system 630 may be configured to be similar to and/or include at least a portion of the example monitoring systems 600, 611, 620 shown in FIGS. 6A-6C. The example monitoring system 630 may include monitoring core processors 604a-604k, performance core processors 606a-606m, one or more chiplets, chips and/or dies 608a-608k, and communication links 610a-610m.

The chiplets, chips and/or dies 608a-608k may be similar to the chiplet architecture 611 described with reference to FIG. 6B. The chiplets, chips and/or dies 608 may have different configurations. For example, some of the chiplets, chips and/or dies 608c-608h, 608i, 608k may be configured to incorporate a monitoring core processor 604 and a single performance core processor/component 606c-606e. As another example, other chiplets, chips and/or dies 608c-608h, 608i, 608k may be configured to incorporate a monitoring core processor 604 and multiple (two or more) performance core processor/components 606a, 606b, 606f, 606g, 606k, 606l. In some embodiments, a portion of the chiplets, chips and/or dies 608i, 608k may be configured to operate as controllers for the operations performed by the example monitoring system 630.

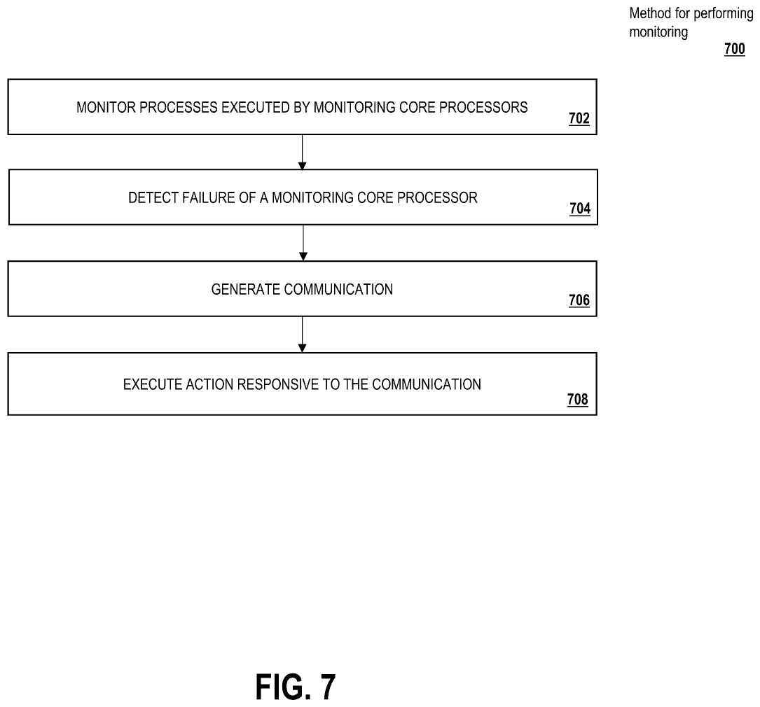

FIG. 6E illustrates an example monitoring system 640 that may be used for monitoring one or more processing cores, according to some implementations of the current subject matter. The example monitoring system 640 may be included in a vehicle (e.g., vehicle 200 described with reference to FIG. 2 and/or device 300 described with reference to FIG. 3). The example monitoring system 640 may perform monitoring of monitoring core processors in a dual and/or pair-wise and/or cyclic and/or multi-monitor fashion to optimize vehicle operations, such as an AV software (e.g., AV software 400 described with reference to FIG. 4 and/or process 700 described with reference to FIG. 7). The example monitoring system 640 may be configured to be similar to and/or include at least a portion of the example monitoring systems 600, 611, 620, 630 shown in FIGS. 6A-6D. The example monitoring system 640 may include monitoring core processors 604a-604k, performance core processors 606a-606m, one or more chiplets, chips and/or dies 608a-608k, communication links 610a-610m, and a switch 642.

The chiplets, chips and/or dies 608a-608k may be similar to the chiplet architecture 611 described with reference to FIG. 6B. The chiplets, chips and/or dies 608 may have different configurations. For example, some of the chiplets, chips and/or dies 608c-608h, 608i, 608k may be configured to incorporate a monitoring core processor 604 and a single performance core processor/component 606c-606e. As another example, other chiplets, chips and/or dies 608c-608h, 608i, 608k may be configured to incorporate a monitoring core processor 604 and multiple (two or more) performance core processor/components 606a, 606b, 606f, 606g, 606k, 606l.

One or more of the performance core processor/components 606a-606m (e.g., one of the set of performance core processor/components 606a, 606b, 606d-606g, 606i-606m incorporated in a single chiplet, chip and/or die 608a, 608c, 608d, 608f, 608g) may be configured as a safety performance core processor/components 606a, 606d, 606f, 606i, 606l. The safety performance core processor/components 606a, 606d, 606f, 606i, 606l may be configured to execute multiple types of operations including their primary operations and back-up operations that are executed in case the primary performance core processor/components 606b, 606e, 606g, 606k, 606m fail. The safety performance core processor/components 606a, 606d, 606f, 606i, 606l may be connected in a hierarchy to dual redundant safety performance core processor/components 606a, 606d, 606f, 606i, 606l for a set system level safety.

The switch 642 can include a switching logic configured to redirect input signals to respective safety performance core processor/components 606a, 606d, 606f, 606i, 606l. The switch 642 can maintain the example monitoring system 640 operational even if one or more performance core processor/components 606b, 606e, 606g, 606k, 606m fail (generate one or more errors or become inoperational by failing to provide an output).

As shown in FIGS. 6A and 6C-6E, each monitoring core processor 604 (and/or 604) may be co-located with (e.g., on the same chiplet/chip/die 608 (and/or 608)) and communicatively coupled to at least one corresponding performance core processor 606 (and/or 606) (e.g., monitoring core processor 604a may be co-located with the performance core processor 606a on the same chip/die 608a, etc., and similarly for processors shown in FIG. 6C). The monitoring core processors 604 (and/or 604) may be further configured to monitor execution of one or more performance processes by the at least one corresponding performance core processor 606 (and/or 606) (e.g., each monitoring core processor monitors (e.g., 604a) its respective performance core processor (e.g., 606a), and similarly for processors shown in FIG. 6C). Further, each performance core processor 606 (and/or 606) may be configured to execute one or more performance core processes (e.g., performance core processor(s) 606 (and/or 606) may execute various tasks associated with components, sensors, etc. in the AV system). Each monitoring core processor 604 (and/or 604) may be communicatively coupled to each of the plurality of monitoring core processors 606 (and/or 606) (e.g., each monitoring core (e.g., 604a (and/or 604a)) may be communicatively coupled to all other monitoring core processors (606b, 606c (and/or 606b, 606c, 606d))). FIG. 7 illustrates an example monitoring process 700, according to some embodiments of the current subject matter. The process 700 may be executed by the example monitoring system 600, 620, 630, 640 shown in FIGS. 6A, 6C-6E, and in particular, by one or more of its monitoring core processors 604 (and/or processors 604 shown in FIG. 6C) that may be co-located on a same chiplet/chip/die 608 (and/or 608a-608d) as their corresponding performance core processors 606 (and/or 606).

At 702, at least one monitoring core processor (e.g., a monitoring core processor 604(a, b, c) and/or 604(a, b, c, d) may perform monitoring of one or more monitoring processes executed by at least another monitoring core processor. The monitoring can be performed by core processors that are co-located within the same chiplet/chip/die and are communicatively coupled to at least one corresponding performance core processor that may be co-located with the performance core processor (as shown in FIGS. 6C-6E). The monitoring core processors (and/or 604) may be further configured to monitor execution of one or more performance processes by the at least one corresponding performance core processor. The performance core processes can be associated with an operation of at least one sensing device of a vehicle. The sensing device can include at least one of the following: a camera, a motion sensor, an image capturing device, a scanner, a keypad sensing device, a LiDAR, a radar, a microphone, an ultrasonic sensor, an inertial sensor, a GPS receiver, an odometry sensor, and any combination thereof, as described with reference to FIG. 2. The performance core processes can be associated with an execution of a maneuver of the vehicle that can be executed in response to processing a signal detected by sensing device(s). In some embodiments, the monitoring processes can be executed using at least one predetermined execution pattern (e.g., dual, paired, cyclic, etc.).

At 704, a failure of a monitoring core processor is detected by another monitoring core processor of the monitoring system. Detection of the failure of the monitoring core processor can include determining that the monitoring core processor is inoperational by failing to generate an output within a set time interval and/or at a set frequency or determining that the monitoring core processor is generating an output including an error (e.g., one or more parameters are outside a set range). In some embodiments, failure detection can include comparing the detected error to an error threshold and classifying the error as negligible if the error is below the threshold and as critical if the error is above the threshold.

At 706, a communication is generated. The communication can include an error report identifying at least one error associated with execution of the one or more performance core processes and detected by the at least another monitoring core processor. The communication can include activating a switch to redirect signal transmission from the failing monitoring core processor of the monitoring system to a respective safety monitoring core processor, configured to perform the operations originally assigned to the failing monitoring core processor. The switch can include management of hardware partitions of the chiplet incorporating the failing monitoring core processor and safety monitoring core processor and the chiplet I/O components. Different partitions of the cluster may correspond to a partition that is dynamically created and associated to an application with a particular process address identifier.

At 708, the safety monitoring core processor may be configured to execute, based on the monitoring, at least one action responsive (e.g., responding to an error, communication from another monitoring core processor 604, via a respective link 610) to at least one communication received from another monitoring core processor. The action can include at least one of the following: adjusting execution of the one or more performance core processes, adjusting execution of the one or more monitoring core processes, executing no action, and any combination thereof.

As stated above, on-chip co-located monitoring and performance core processors as well as connections between monitoring core processors may reduce the number of chips in a system and provide further scalability of the system(s) in the autonomous vehicle. Further, on-chip connections may provide higher reliability of the entire system, where each monitoring core processor may be configured to perform peer monitoring and detection of errors, faults, etc., thereby speeding up taking any requisite responses and/or mitigation actions. Integration of monitoring cores may also improve access to any and/or all hardware signals to be monitored at SoC design time. Further, peer-to-peer monitoring may enable a single-point fault tolerance, whereby failure of one monitoring core processor may be negligible, as other monitoring core processors may be able to continue performance of the failed monitoring core processes. The peer-to-peer monitoring system may also provide ready access to safety-rated computation with simplified implementation due to dedicated hardware design with few touchpoints through monitoring core processors. In some embodiments, the system and/or methods for monitoring, as disclosed herein, may be compliant with various safety standards (e.g., ISO 26262).

According to some non-limiting embodiments or examples, provided is a system, comprising: a plurality of monitoring core processors, each monitoring core processor in the plurality of monitoring core processors being communicatively coupled to each of the plurality of monitoring core processors; and a plurality of performance core processors, each performance core processor in the plurality of performance core processors configured to execute one or more performance core processes; each monitoring core processor in the plurality of monitoring core processors being co-located with and communicatively coupled to at least one corresponding performance core processor in the plurality of performance core processors, and further configured to monitor execution of one or more performance processes by the at least one corresponding performance core processor; wherein at least one monitoring core processor in the plurality of monitoring core processors is configured to monitor one or more monitoring processes executed by at least another monitoring core processor in the plurality of monitoring core processors, and execute, based on the monitoring, at least one action responsive to at least one communication received from the at least another monitoring core processor.

According to some non-limiting embodiments or examples, provided is at least one non-transitory computer-readable medium comprising one or more instructions that, when executed by at least one processor, cause the at least one processor to perform operations comprising: monitoring, using at least one monitoring core processor in a plurality of monitoring core processors, one or more monitoring processes executed by at least another monitoring core processor in the plurality of monitoring core processors, wherein each monitoring core processor in the plurality of monitoring core processors is co-located with and communicatively coupled to at least one corresponding performance core processor of a plurality of performance core processors, and further configured to monitor execution of one or more performance processes by the at least one corresponding performance core processor; each performance core processor in the plurality of performance core processors is configured to execute one or more performance core processes; each monitoring core processor in the plurality of monitoring core processors is communicatively coupled to each of the plurality of monitoring core processors; and executing, using the at least one monitoring core processor, based on the monitoring, at least one action responsive to at least one communication received from the at least another monitoring core processor.

According to some non-limiting embodiments or examples, provided is a method, comprising: monitoring, using at least one monitoring core processor in a plurality of monitoring core processors, one or more monitoring processes executed by at least another monitoring core processor in the plurality of monitoring core processors, wherein each monitoring core processor in the plurality of monitoring core processors is co-located with and communicatively coupled to at least one corresponding performance core processor of a plurality of performance core processors, and further configured to monitor execution of one or more performance processes by the at least one corresponding performance core processor; each performance core processor in the plurality of performance core processors is configured to execute one or more performance core processes; each monitoring core processor in the plurality of monitoring core processors is communicatively coupled to each of the plurality of monitoring core processors; and executing, using the at least one monitoring core processor, based on the monitoring, at least one action responsive to at least one communication received from the at least another monitoring core processor.

Further non-limiting aspects or embodiments are set forth in the following numbered clauses:

Clause 1: A method comprising: monitoring, using at least one monitoring core processor in a plurality of monitoring core processors, one or more monitoring processes executed by at least another monitoring core processor in the plurality of monitoring core processors, wherein each monitoring core processor in the plurality of monitoring core processors is co-located with and communicatively coupled to at least one corresponding performance core processor of a plurality of performance core processors, and further configured to monitor execution of one or more performance processes by the at least one corresponding performance core processor; each performance core processor in the plurality of performance core processors is configured to execute one or more performance core processes; each monitoring core processor in the plurality of monitoring core processors is communicatively coupled to each of the plurality of monitoring core processors; and executing, using the at least one monitoring core processor, based on the monitoring, at least one action responsive to at least one communication received from the at least another monitoring core processor.

Clause 2: The method of clause 1, wherein each monitoring core processor in the plurality of monitoring core processors is co-located using a common integrated circuit with the at least one corresponding performance core processor.

Clause 3: The method of clause 2, wherein the one or more performance core processes is associated with an operation of at least one sensing device of a vehicle, the at least one sensing device comprising at least one of the following: a camera, a motion sensor, an image capturing device, a scanner, a keypad sensing device, a LiDAR, a radar, a microphone, an ultrasonic sensor, an inertial sensor, a GPS receiver, an odometry sensor, and any combination thereof.

Clause 4: The method of any of the preceding clauses, wherein the one or more performance core processes is associated with execution of at least one maneuver of a vehicle.

Clause 5: The method of any of the preceding clauses, wherein the at least one communication comprises an error report identifying at least one error associated with execution of the one or more performance core processes and detected by the at least another monitoring core processor.

Clause 6: The method of any of the preceding clauses, further comprising detecting a failure of the at least another monitoring core processor; using at least a third monitoring core processor in the plurality of monitoring core processors to monitor the one or more monitoring processes previously executed by at least another monitoring core processor based on the detected failure; and receiving the at least one communication from the third monitoring core processor.

Clause 7: The method of any of the preceding clauses, wherein the one or more monitoring processes are executed using at least one predetermined execution pattern.

Clause 8: The method of any of the preceding clauses, wherein the at least one action comprises at least one of the following: adjusting execution of the one or more performance core processes, adjusting execution of the one or more monitoring core processes, executing no action, and any combination thereof.

Clause 9: A system, comprising: at least one processor, and at least one non-transitory storage media storing instructions that, when executed by the at least one processor, cause the at least one processor to perform operations of any of the preceding clauses.

Clause 10: At least one non-transitory storage media storing instructions that, when executed by at least one processor, cause the at least one processor to perform operations of any of the preceding clauses.

Clause 11: A system comprising: a plurality of monitoring core processors, each monitoring core processor in the plurality of monitoring core processors being communicatively coupled to each of the plurality of monitoring core processors; and a plurality of performance core processors, each performance core processor in the plurality of performance core processors configured to execute one or more performance core processes; each monitoring core processor in the plurality of monitoring core processors being co-located with and communicatively coupled to at least one corresponding performance core processor in the plurality of performance core processors, and further configured to monitor execution of one or more performance processes by the at least one corresponding performance core processor; wherein at least one monitoring core processor in the plurality of monitoring core processors is configured to monitor one or more monitoring processes executed by at least another monitoring core processor in the plurality of monitoring core processors, and execute, based on the monitoring, at least one action responsive to at least one communication received from the at least another monitoring core processor.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

What is claimed is:

1. A method comprising:
monitoring, using at least one monitoring core processor in a plurality of monitoring core processors, one or more monitoring processes executed by at least another monitoring core processor in the plurality of monitoring core processors, wherein
each monitoring core processor in the plurality of monitoring core processors is co-located with and communicatively coupled to at least one corresponding performance core processor of a plurality of performance core processors, and further configured to monitor execution of one or more performance processes by the at least one corresponding performance core processor;
each performance core processor in the plurality of performance core processors is configured to execute one or more performance core processes;
each monitoring core processor in the plurality of monitoring core processors is communicatively coupled to each of the plurality of monitoring core processors; and
executing, using the at least one monitoring core processor, based on the monitoring, at least one action responsive to at least one communication received from the at least another monitoring core processor.

2. The method of claim 1, wherein each monitoring core processor in the plurality of monitoring core processors is co-located using a common integrated circuit with the at least one corresponding performance core processor.

3. The method of claim 2, wherein the one or more performance core processes is associated with an operation of at least one sensing device of a vehicle, the at least one sensing device comprising at least one of the following: a camera, a motion sensor, an image capturing device, a scanner, a keypad sensing device, a LiDAR, a radar, a microphone, an ultrasonic sensor, an inertial sensor, a GPS receiver, an odometry sensor, and any combination thereof.

4. The method of claim 1, wherein the one or more performance core processes is associated with execution of at least one maneuver of a vehicle.

5. The method of claim 1, wherein the at least one communication comprises an error report identifying at least one error associated with execution of the one or more performance core processes and detected by the at least another monitoring core processor.

6. The method of claim 1, further comprising
detecting a failure of the at least another monitoring core processor;
using at least a third monitoring core processor in the plurality of monitoring core processors to monitor the one or more monitoring processes previously executed by at least another monitoring core processor based on the detected failure; and
receiving the at least one communication from the third monitoring core processor.

7. The method of claim 1, wherein the one or more monitoring processes are executed using at least one predetermined execution pattern.

8. The method of claim 1, wherein the at least one action comprises at least one of the following: adjusting execution of the one or more performance core processes, adjusting execution of the one or more monitoring core processes, executing no action, and any combination thereof.

9. A system, comprising:
at least one processor, and
at least one non-transitory storage media storing instructions that, when executed by the at least one processor, cause the at least one processor to perform operations comprising:
monitoring, using at least one monitoring core processor in a plurality of monitoring core processors, one or more monitoring processes executed by at least another monitoring core processor in the plurality of monitoring core processors, wherein
each monitoring core processor in the plurality of monitoring core processors is co-located with and communicatively coupled to at least one corresponding performance core processor of a plurality of performance core processors, and further configured to monitor execution of one or more performance processes by the at least one corresponding performance core processor;
each performance core processor in the plurality of performance core processors is configured to execute one or more performance core processes;
each monitoring core processor in the plurality of monitoring core processors is communicatively coupled to each of the plurality of monitoring core processors; and
executing, using the at least one monitoring core processor, based on the monitoring, at least one action responsive to at least one communication received from the at least another monitoring core processor.

10. At least one non-transitory storage media storing instructions that, when executed by at least one processor, cause the at least one processor to perform operations comprising:
monitoring, using at least one monitoring core processor in a plurality of monitoring core processors, one or more monitoring processes executed by at least another monitoring core processor in the plurality of monitoring core processors, wherein
each monitoring core processor in the plurality of monitoring core processors is co-located with and communicatively coupled to at least one corresponding performance core processor of a plurality of performance core processors, and further configured to monitor execution of one or more performance processes by the at least one corresponding performance core processor;
each performance core processor in the plurality of performance core processors is configured to execute one or more performance core processes;
each monitoring core processor in the plurality of monitoring core processors is communicatively coupled to each of the plurality of monitoring core processors; and
executing, using the at least one monitoring core processor, based on the monitoring, at least one action responsive to at least one communication received from the at least another monitoring core processor.
